(19) United States
(12) Patent Application Publication
(10) Pub. No.: US 2008/0148471 A1
(43) Pub. Date: Jun. 26, 2008

(54) Portable spa with sequenced jet pulsations

(76) Inventor: Bradford Thomas Tatum, Clearwater, FL (US)

Correspondence Address: MCDERMOTT, WILL & EMERY LLP, 227 WEST MONROE STREET, SUITE 4400, CHICAGO, IL, 60606-5096, US

(21) Appl. No.: 11/998,080

(22) Filed: Nov. 28, 2007

Related U.S. Application Data
(60) Provisional application No. 60/861,348, filed on Nov. 28, 2006.

(51) Int. Cl. A47K 3/10; A61H 33/00; E03C 1/08

(52) U.S. Cl. 4/541.6; 4/541.1; 137/565.01

(57) ABSTRACT

The present invention is directed to a portable spa comprising a shell with an arrangement of seats, and a water pulsation system associated with one of the seats. The pulsation system includes a pump that supplies water to a primary manifold that has a plurality of discharge ports. A secondary manifold assembly is connected to each discharge port, and has both a valve and a plurality of discharge ports. A grouping of jets is associated with each secondary manifold assembly. Each jet grouping includes a plurality of jets wherein each jet is connected to the respective discharge port of the secondary manifold assembly. A module has a plurality of programmed operating modes that control the operation of the valves in the secondary manifold assembly for sequenced distribution of water from the jets. During operation of the pulsation system, the pump, the primary and secondary manifolds, and the module collectively interact to supply water to the various jet groupings whereby the jets discharge the water into the shell in a phased manner according to the operating mode. The phased discharge of water from the jets provides a “pulsing” application of water upon the user's body which increases the spa's therapeutic benefits.

### CROSS-REFERENCE TO RELATED APPLICATIONS

This application claims the benefit of U.S. Provisional Patent Application Ser. No. 60/861,348, filed Nov. 28, 2006.

### FEDERALLY SPONSORED RESEARCH OR DEVELOPMENT

N/A

### TECHNICAL FIELD

The invention relates to a portable spa featuring a water pulsation system for the jets that sequentially deliver water into the spa. More specifically, the invention provides a portable spa or hot tub with a pulsation system whereby water is supplied to and discharged from the jet assemblies in distinct sequences or phases, which provides a “pulsing” application of water upon the user's body and increases the spa's therapeutic benefits. To further increase the therapeutic benefits, the spa includes a detachable massage ball.

### BACKGROUND OF THE INVENTION

Portable spas, or hot tubs as they are also referred to, are well-known and can be found in both residential and commercial settings. Most portable spas include an arrangement of seats, such as recline, captain's and waterfall seats, and an array of jets, such as directional, deep tissue, bullet, pulsing, and oscillating jets, incorporated within each seat. Water is pumped by an electric motor through lines or conduits to the jets that then discharge the water into the shell. Depending upon the number of jets in each seat, a manifold may be utilized between the pump and the jets to facilitate delivery of the water. As an example, a conventional spa has four seats wherein each seat has ten jets that are supplied with water pumped through a manifold by the motor. Depending upon the number of seats and jets, a second motor may be employed wherein each motor pumps water to multiple seats and jets therein.

While such conventional portable spas provide some benefits, they nevertheless have certain limitations. For example, when the conventional spa is operating, all of the jets continuously discharge water into the spa shell in a static or fixed discharge pattern dictated by the placement of the jets. As a result, those people utilizing the spa cannot alter the water delivery provided by the jets or vary the application of water on their body. The static discharge pattern and inability to vary the water application can become monotonous to the user and lessen the therapeutic benefits provided by the spa. Over time, this limitation may lead the spa owner to become disenchanted with the performance of the portable spa.

The present invention is provided to solve the limitations of conventional portable spas discussed above and other problems, and to provide advantages and aspects not provided by prior portable spas. A full discussion of the features and advantages of the present invention is deferred to the following detailed description, which precedes with reference to the accompanying drawings.

### SUMMARY OF THE INVENTION

The present invention is directed to a portable spa featuring a water pulsation system wherein jets discharge the water into the spa shell in a sequenced or phased manner that provides a “pulsing” application of water upon the user's body. The spa shell or tub includes a seating arrangement, wherein the pulsation system is associated with an individual seat. The pulsation system comprises a pump, a suction assembly that supplies water to the pump, and a primary manifold assembly that receives water from the pump. The primary manifold assembly includes a valve assembly and a plurality of discharge ports.

According to another aspect of the invention, a secondary manifold assembly is connected to each discharge port of the primary manifold by a conduit or line. The secondary manifold assembly includes a valve connected to the conduit, and a manifold with a plurality of discharge ports. The pulsation system further comprises a grouping of jets or jet groups that include at least one jet assembly, wherein water is supplied to the jet group by a flexible conduit or line extending from a discharge port. The jet groups represent distinct regions of the seat where water is discharged from during the operation of the pulsation system. The pulsation system further includes a module loaded with a number of operating modes or programs that control the phased discharge of water from the jet groups. The operating modes enable the module to control the operation of the secondary manifold assembly, principally the valves, and the supply of water to the jets. A module interface mounted in the shell adjacent the seat is linked to the module to allow for user operation and/or adjustment of the pulsation system. The interface includes a number of depressible buttons that correspond to the various operating modes and a graphical display showing the particular stage of water pulsation relative to the human body. In addition, the module is linked or operably connected to a primary controller, which monitors the pulsation system and controls other spa components, including the ozonator and heater.

According to another aspect of the invention, the operation of the pulsation system involves both a location component and a time component, wherein water is discharged from different jet groups over set time intervals. Consequently, the person sitting in the seat experiences a pulsing application of water upon his/her body as water is discharged from the various jet groups, not a static discharge of water from all jets. Once the user selects the desired operating mode on the module controller, the module sends a series of signals to the other components of the pulsation system to effectuate the operating mode. Unlike conventional spas with fixed water discharge, the pulsation system varies the water discharge locations whereby the user experiences water pulses on his/her body. This pulsation of water on the body increases the hyrdotherapeutic benefits of the spa. Also, as the various phases are progressing, the module controller graphically displays the status of the operating mode, including the location of the discharged water relative to the user's body

According to another aspect of the invention, the therapeutic benefits of the spa are further enhanced by a massage ball assembly that is detachably connected to the shell. The massage ball assembly includes a housing that rotatably supports a ball while it is applied to the body. The shell includes a receiver, preferably formed in the shell, that removably receives the ball assembly. To obtain a personalized massage within the spa, the spa user simply removes the ball assembly from the recess and then grasps the housing while applying the ball on the body. Because the ball is suspended within the housing, the ball rotates as it is applied to the body.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an overhead view of a portable spa of the invention, showing a spa shell with a pulsation system associated with the two seats positioned adjacent a water filtration assembly;

FIG. 2 is a perspective view of the portable spa, showing the shell with a seat having the pulsation system and distinct groupings of jet assemblies;

FIG. 3 is a perspective view of the portable spa, showing the shell with a seat having the pulsation system;

FIG. 4 is a perspective view of the portable spa, showing the seat of FIG. 2 in an operational mode wherein water is being discharged from a single jet grouping;

FIG. 5 is a schematic of the portable spa, showing two pulsation systems, each associated with a spa seat and operably connected to the primary controller of the spa.

FIG. 6 is a perspective view of the portable spa, showing a primary controller interface mounted to the shell;

FIG. 7 is a perspective view of the portable spa, showing a module interface of the pulsation system mounted to the shell proximate the seat of FIG. 2;

FIG. 8 is a perspective view of the portable spa, showing a detachable massage ball assembly removably connected to the spa shell;

FIG. 9 is a perspective view of the portable spa, showing a receiver in the shell that removably receives the massage ball assembly; and,

FIG. 10 is a side view of the portable spa, showing the massage ball assembly.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

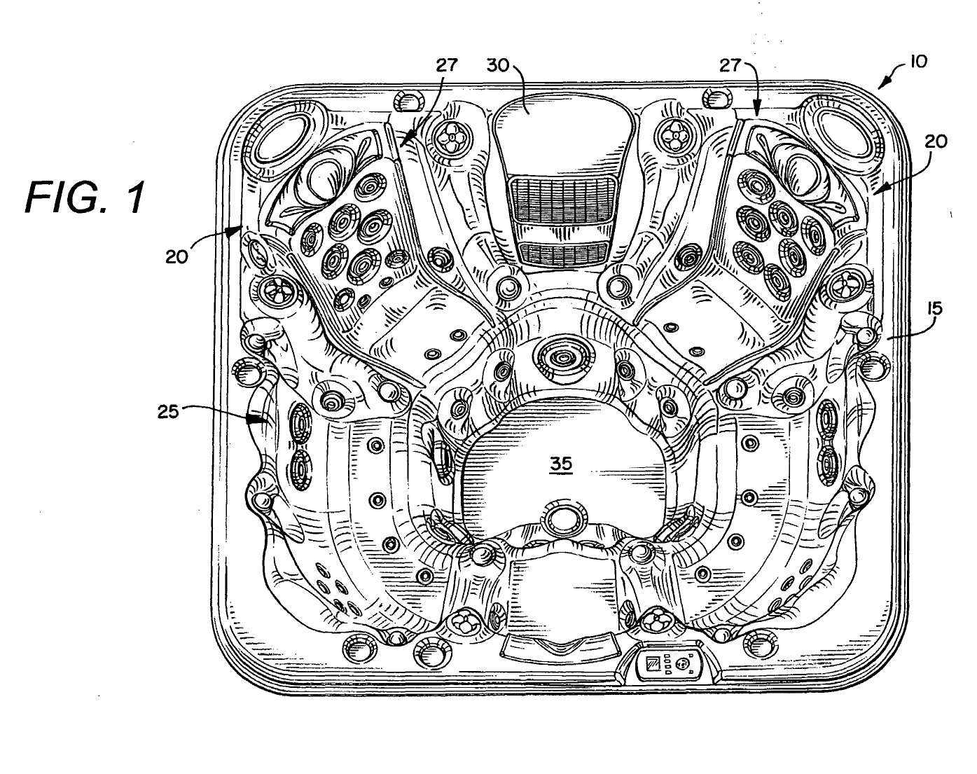

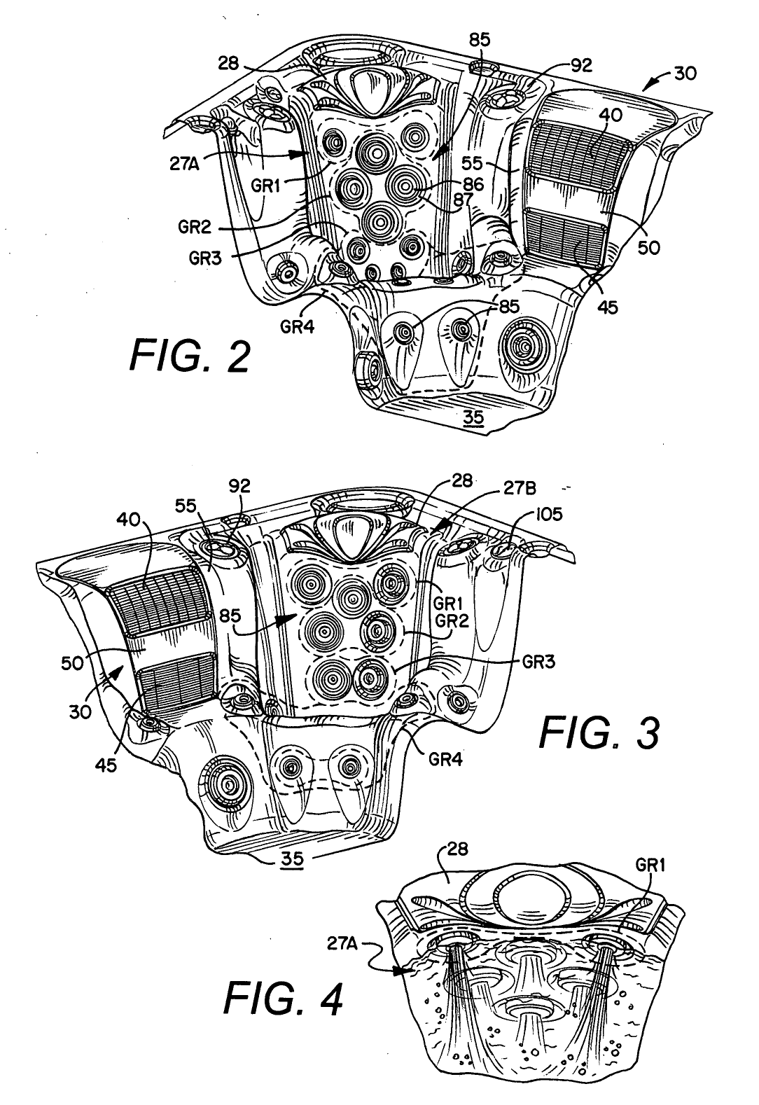

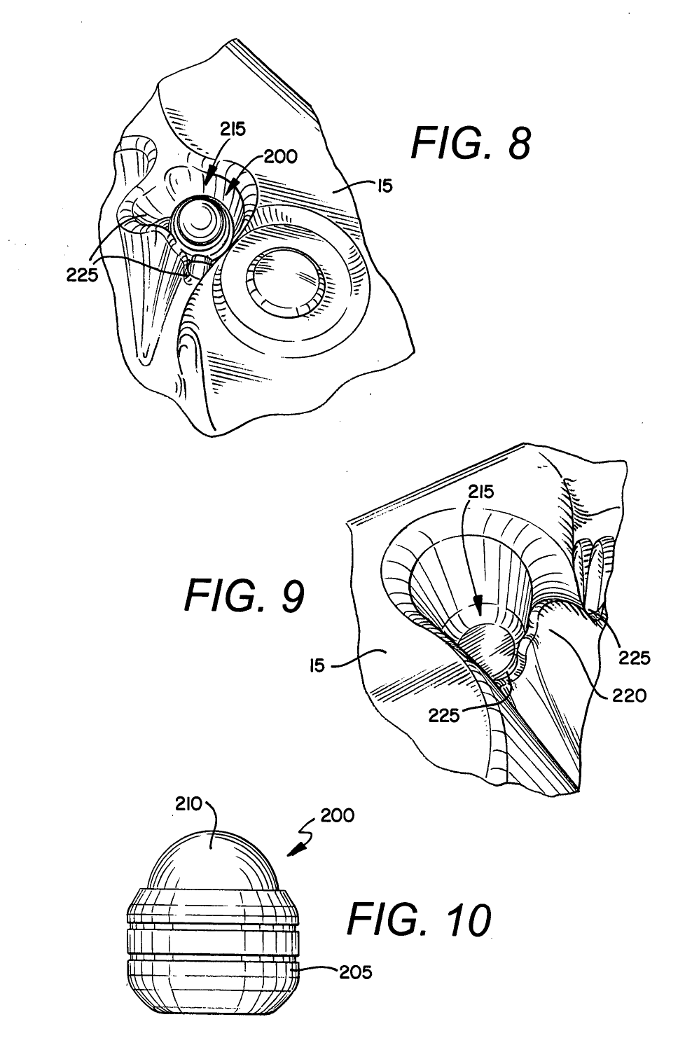

FIGS. 1-14 illustrate a portable spa 10 of the invention that includes a spa shell or tub 15 and a pulsation system 20 for water discharged into the shell 15. The shell 15 includes a seating arrangement 25, wherein a pulsation system 20 is associated with each of the two seats 27 that are positioned about the water filtration assembly 30. In this manner, there is a 1:1 ratio of a pulsation system 20 to a seat 27. Although shown as having two seats 27 with the pulsation system 20, the shell 15 may have more or less seats, where each seat has its own pulsation system 20. As an example, the shell 15 has four seats 27, each having a pulsation system 20. The shell 15 further includes a foot well 35, wherein the seats 27 extend into the well 35. Referring to FIGS. 2 and 3, the water filtration assembly 30 includes an upper grill 40 and a lower grill 45 incorporated in a curvilinear housing 50 that extends downward from an upper portion of the shell 15. The housing 50 is mounted to a flange 55 formed in the shell 15. At least one filter cartridge or element is mounted within the assembly 30 and behind the grills 40, 45. The shell 15 is supported by a support frame 57 (see FIG. 8) that comprises a plurality of horizontal frame members and vertical frame members. Various operational components that are utilized to operate the spa 10 are installed within a cavity defined between the support frame 57 and the shell 15. These operational components generally include an ozonator, an electrical connection interface, a primary controller 58 (see FIG. 14), and a heater assembly. The primary controller 58 includes a microprocessor for operational control of these components and monitoring of the pulsation system 20, as explained below.

FIG. 14 is a schematic representation of the pulsation systems 20 for the two seats 27 flanking the filtration assembly 30—designated seat 27A and seat 27B. In this embodiment, the other seats within the shell 15 lack the pulsation system 20. As explained above, a pulsation system 20 is associated with an individual seat 27 and comprises a pump 60, a suction assembly 65 that supplies water to the pump 60, and a primary manifold assembly 70 that receives water from the pump 60. The pump 60 preferably has multiple speeds and is rated 1.0-1.5 horsepower. To ensure that a sufficient quantity and pressure of water is supplied, the pump 60 interacts with the primary controller 58 via the electrical leads 61 that extend there between. At least one other pump (not shown) supplies water to the other seats in the seating arrangement 25 that lack the pulsation system 20. The suction assembly 65 includes at least one inlet 66, preferably located in the foot well 35, that draws water into the assembly 65. The primary manifold assembly 70 includes a valve assembly 71, such as a manually actuated valve, and a plurality of discharge ports or outlets 72. Referring to FIG. 9, the primary manifold 70 is secured in place by a bracket 73 that extends upward from a base 16 of the spa 10.

A secondary manifold assembly 75 is connected to each discharge port 72 of the primary manifold 70 by a flexible conduit or line 76. The secondary manifold assembly 75 includes a valve 77 connected to the conduit 76, and a manifold 78 with a plurality of discharge ports or outlets 79. In one embodiment, the valve 77 is an electromagnetic valve. The pulsation system 20 further comprises a grouping of jets or jet groups 80 that include at least one jet assembly 85, wherein water is supplied to the jet group 80 by a flexible conduit or line 81 extending from a discharge port 79. As shown in FIG. 14, there are four distinct jet groups 80—GR1, GR 2, GR 3 and GR 4—each having a plurality of jet assemblies or jets 85. The total number of jet groups 80 and jets 85 varies with the design parameters of spa 10, including the flow rates of the jets 85 (roughly 7 GPM) and the operating characteristics of the pump 60. However, the total number of jets 85 should not exceed the ability of the pump 60 to supply water without surging. Therefore, the combined flow rate of all jets 85 should not exceed the output flow capacity of pump 60 at a reasonable operating pressure, such as 10 psi. The jets 85 can be of varying types including directional, deep tissue, bullet, dual-action, pulsing, and oscillating jets. An air manifold assembly 90 supplies air to the jet groups 80, and includes a flexible conduit or line 91 leading to each jet 85. An adjustable intake control 92 residing in an upper portion of the shell 15 (see FIGS. 2 and 3) can vary the amount of air supplied to the manifold assembly 90.

As shown in FIGS. 2 and 3, the jet assembly 85 includes a discharge nozzle 86, which may be adjustable to vary the discharge pattern, and a bezel 87. The jet 85 extends through the shell 15 and further includes a stem that connects with the supply line 81. The dimensions of the jets 85 within each group 80 vary from 2-5 inches in diameter.

In the embodiment of FIG. 14, a single line 81 is shown as having a branch segment whereby two jets 85 are supplied by the same line 81 and discharge port 79. Alternatively, each jet assembly 85 is supplied by a single line 81 extending from a discharge port 79, wherein the number of jets 85, lines 81 and discharge ports 79 are equal to provide dedicated water supply to each jet 85. While the jets 85 in each group 80 are depicted as being horizontally aligned below the water line in FIG. 14, the jets 85 may be aligned in a different manner when installed in the seat 27. Referring to FIG. 2, the left seat 27A has a first jet group GR 1 that comprises two smaller jets 85 positioned in an upper portion of the seat 27A and below the head cushion 28. In use and when the associated valve 77 is open, the first jet group GR 1 supplies water to a spa user's shoulder and neck regions. A second jet group GR 2 comprises a cluster of four larger jets 85 in a central portion of the seat 27A that supply water to the user's upper back. A third jet group GR 3 comprises four intermediate sized jets 85 arrayed in a curvilinear path to supply water to the user's lower back. A fourth jet group GR 4 comprises a pair of jets 85 located at the user's hip region, a pair of jets 85 located at the user's wrist and hand region, and a pair of jets 85 at the user's calf region. To increase the hydrotherapy benefits provided by the pulsation system 20, the fourth jet group GR 4 can be expanded to include other jets 85, such as waterfall jets located beyond the seats 27 but within the seating arrangement 25. As shown in FIG. 3, the seat 27B has a different arrangement of jets 85 that define the jet groups GR 1-4. As explained below, the jet groups GR 1-4 represent distinct regions of the seat 27 where water is discharged from during the operation of the pulsation system 20. Although the jet groups GR 1-4 vertically divide the seat 27 into distinct regions, the jet groups GR 1-4 can be rearranged to divide the seat 27 into lateral or side regions, whereby the person sitting in the seat 27 would experience lateral water discharge instead of vertical water discharge from the jets 85.

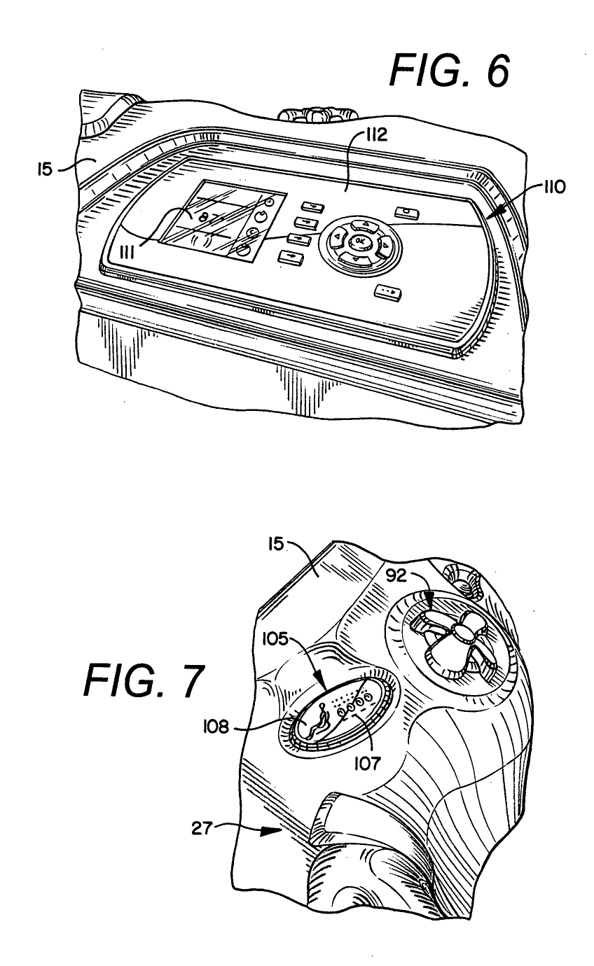

The pulsation system 20 further includes a microprocessor-based pulsation module 100 loaded with a number of operating modes or programs that control the operation of the pulsation system 20, including the sequenced or phased discharge of water from the jet groups 80. Specifically, the operating modes enable the module 100 to control the operation of the secondary manifold assembly 75, principally the valves 77, and the supply of water to the jets 85. The module 100 is linked to each valve 77 of the manifold assembly 75 by electrical leads 101. The module 100 is linked or operably connected to the primary controller 58 by electrical leads 102. As explained in greater detail below where the operation of the pulsation system 20 is discussed, the module 100 sends a signal through the lead 101 to the manifold assembly 75 to open or close the valve 77 to control the flow of water to the various jet groups 80. A pulsation module interface 105 is linked to the module 100 by leads 106 to allow for user operation and/or adjustment of the pulsation system 20. As shown in FIG. 6, the interface 105 is preferably mounted in the shell 15 adjacent the seat 27 such that the occupant of the seat 27A, B can easily set and/or adjust the operating modes of the pulsation system 20 without leaving the seat 27. In the embodiment of FIG. 6, the interface 105 includes a number of depressible buttons 107 that correspond to the various operating modes and a graphical display 108 showing the particular stage of water pulsation relative to the human body.

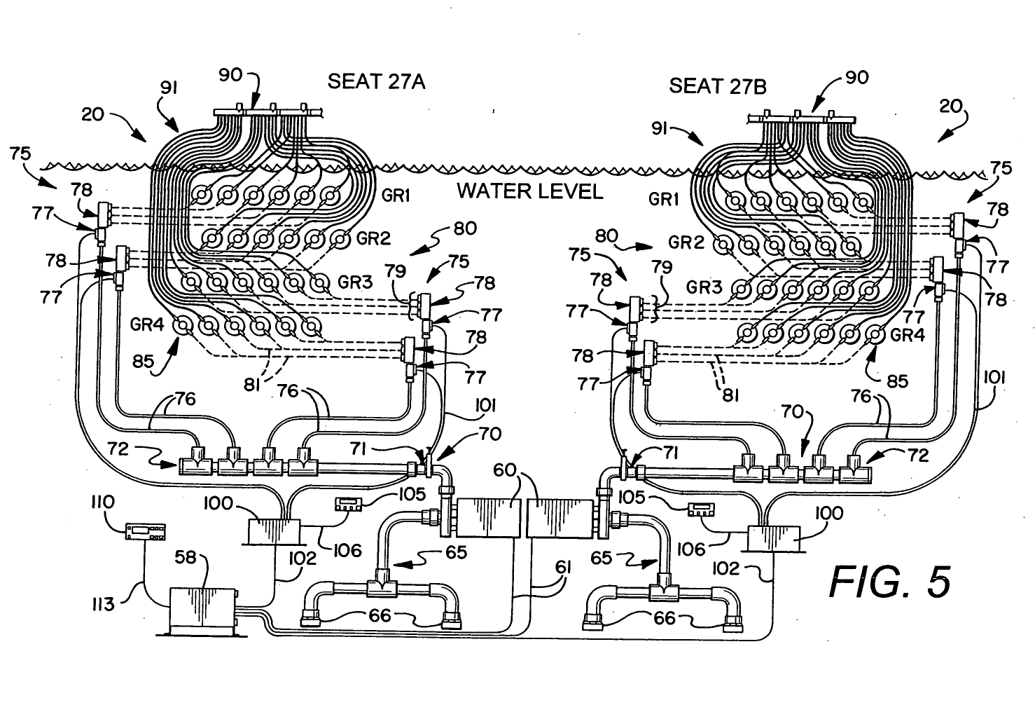

Referring to FIG. 5 and FIG. 14, a primary controller interface 110 is linked with the primary controller 58 and resides in an upper portion of the shell 15. The primary controller interface 110 includes a window 111 that displays the operating status of the spa 10, including the pulsation system 20. Also, the interface 110 has a plurality of depressible buttons 112 to navigate the programs utilized for operation of the spa 10. As shown in FIG. 14, the interface 110 is linked to the controller 58 by electrical leads 113. In a preferred embodiment, the primary controller 58 monitors operation of the pulsation system 20, however, operational control of the pulsation system 20 resides with the interface 105 and the module 100. In this manner, the spa user can power-up the spa 10 with the interface 110, while the person in the seat 27A, 27B controls the operation of the pulsation system 20 with the module interface 105. In another embodiment, both the primary controller 58 and the module 100/interface 105 are configured to provide operational control of the pulsation system 20. In yet another embodiment, the spa 10 includes a wireless remote control unit (not shown) that sends signals to the primary interface 110 and/or the module interface 105 for operational control. In this arrangement, the shell 15 may include a recessed cavity that receives the remote control unit, which can be sealed within a waterproof housing and formed from a buoyant material so that the unit floats.

As shown in FIG. 14, the spa 10 has two distinct two pulsation systems 20, wherein each pulsation system 20 is associated with a single seat 27A, B and features a pump 60, primary and secondary manifolds 70 and 75, jet groups 80, a module 100 and module interface 105. However, the two pulsation systems 20 are integrated with a single primary controller 58 and controller interface 110, which have the capacity to monitor the operation of the pulsation systems 20. Additional pulsation systems 20 can be added to other seats in the shell 15 and integrated with the primary controller 58, while the primary controller 58 maintains its role in monitoring the operation of the systems 20. For example, the spa 10 may include four pulsation systems 20, each associated with a seat 27 and operably connected to the primary controller 58 in a manner consistent with that discussed above and shown in FIG. 14. Thus, in a preferred embodiment of the spa 10, a single primary controller 58 has the ability to monitor multiple pulsation systems 20, while also monitoring and controlling the operation of the ozonator, heater and pumps that supply water to seats not having a pulsation system 20.

The operation of the pulsation system 20 involves both a location component and a time component, wherein water is sequentially discharged from different jet groups 80 for an interval of time. Consequently, and in contrast to conventional spas, the person sitting in the seat 27 experiences a pulsing application of water upon his/her body as water is discharged from the various jet groups 80, not a static discharge of water from all jets 80. The pulsation system 20, namely the module 100, is programmed with operating modes that control the sequencing of the valves 77 and the resultant discharge of water from the various jet groups 80. The operation of the pulsation system 20 will be discussed from the vantage point of a person sitting in one of seats 27A, B, hereinafter referred to as the “User.” Once the spa 10 is operating, the User activates the pulsation system 20 by depressing the buttons 107 on the module interface 105 to select a desired operating mode for the module 100. Depending upon how the operating modes are defined, water may be supplied to the four jet groups 80 in sequential order, repeating or random, and for set or random time periods. Also, the speed of the water discharged from the jets 85, for example high, medium or low speeds, can be adjusted in the operating mode with the controller 105. In one embodiment, the operating modes of the module 100 are programmed at the manufacturing facility. In another embodiment, some of the operating modes are pre-programmed and the remaining modes can be programmed by a service technician or the spa owner upon installation of the spa 10.

Once the User selects the desired operating mode on the controller 105, for example a sequential mode, the module 100 sends a series of signals to the other components of the pulsation system 20 to effectuate the operating mode. Specifically, the module 100 sends a first signal to the primary controller 58, which then either relays that signal or sends a second signal to the pump 60 to supply a sufficient quantity of water to the primary manifold assembly 70 for further distribution to the secondary manifold assembly 75 and the jet groups 80. Thus, the pump 60 operates in a dedicated manner—supplying water to only the jet groups 80 in the pulsation system 20. The primary controller 58 sends a third signal to the controller interface 110 to graphically show operation of the pulsation system 20 in the window 111. The module 100 sends a fourth signal to the valve 77 in the first jet group GR 1, wherein the valve 77 opens and water is supplied through the manifold 78 and the lines 81 to the jets 85 for discharge into the shell 15 (see FIG. 4). The valve 77 remains open for a fixed time interval, such as 3-20 seconds, until a fifth signal is sent by the module 100 to close the valve 77. A sixth signal is sent by the module 100 to the valve 77 in the second jet group GR2, wherein the valve 77 opens and water is supplied through the manifold 78 and the lines 81 to the jets 85 for discharge into the shell 15. The valve 77 remains open for a fixed time interval, which corresponds to the previous time interval, until a seventh signal is sent by the module 100 to close the valve 77. An eighth signal is sent by the module 100 to the valve 77 in the third jet group GR3, wherein the valve 77 opens and water is supplied through the manifold 78 and the lines 81 to the jets 85 for discharge into the shell 15. The valve 77 remains open for the fixed time interval until a ninth signal is sent by the module 100 to close the valve 77. A tenth signal is sent by the module 100 to the valve 77 in the fourth jet group GR4, wherein the valve 77 opens and water is supplied through the manifold 78 and the lines 81 to the jets 85 for discharge into the shell 15. The valve 77 remains open for the fixed time interval until an eleventh signal is sent by the module 100 to close the valve 77. This signaling process repeats provided the User has not paused the operating mode or changed the mode via the controller 105. In this manner, the components of the pulsation system 20, including the pump 60, the primary and secondary manifolds 70, 75, the module 100, and the module controller 105 continuously interact with each other and the primary controller 58 during the operating mode to ensure that sufficient amounts of water are timely delivered to the jet groups 80 for discharge into the spa 15.

Although the time intervals in the above steps are constant, the User can vary the time interval for the water discharged from each jet group 80. During the sequential mode, air is supplied to the jets 85 of the jet groups 80 through the lines 91 by the air intake manifold 90. As the sequential mode is progressing through its various stages, the User feels the discharge of water from the various jets 85 positioned throughout the seat 27. Unlike conventional spas with fixed water discharge, the pulsation system 20 varies the water discharge locations whereby the User experiences water pulses on his/her body. This pulsation of water on the body increases the hyrdotherapeutic benefits of the spa 10. Also, as the various stages are progressing, the controller 105 graphically displays the status of the operating mode, including the location of the discharged water relative to the User's body. During the operating mode, the User may pause the mode to prolong the water discharge from a desired jet group 80. Because a pulsation system 20 is associated with each seat 27A, B, a second User sitting in the other seat may separately utilize the other pulsation system 20. For example, a first User in seat 27A can operate the associated pulsation system 20 in a sequential mode, while a second User in seat 27B can operate the associated pulsation system 20 in a random mode. Consequently, two different Users can experience the benefits provided by the pulsation system 20 while in the spa 10. When the spa 10 is initially started, the pulsation system 20 is in a default mode wherein all valves 77 are open and water is flowing through all jets 85 in the jet groups 80. Alternatively, the module 100 can be programmed to initiate one of the operating modes upon start-up.

To further increase the therapeutic benefits of the spa 10, a massage ball assembly 200 (see FIGS. 11-13) is detachably connected to the shell 15. The massage ball assembly 200 includes a housing 205 that rotatably supports a ball 210 while it is applied to the body. The shell 15 includes a receiver 215, preferably formed in the shell 15, that removably receives the ball assembly 200. A contoured engaging member 220 is flanked by two recesses 225 that allow for the drainage of water that has accumulated within the receiver 215. To obtain a personalized massage within the spa 10, the spa user simply removes the ball assembly 200 from the recess and then grasps the housing 205 while applying the ball 210 on the body. Because the ball 210 is suspended within the housing 205, the ball 210 rotates as it is applied to the body.

While the specific embodiments have been illustrated and described, numerous modifications come to mind without significantly departing from the spirit of the invention, and the scope of protection is only limited by the scope of the accompanying Claims.

What is claimed is:

1. A portable spa comprising:
a shell having an arrangement of seats; and,
a pulsation system associated with one of the seats, wherein the pulsation system comprises:
a pump;
a primary manifold assembly that receives water from the pump, the primary manifold assembly having a first plurality of discharge ports;
a secondary manifold assembly connected to each discharge port of the primary manifold, the secondary manifold assembly having a valve and a second plurality of discharge ports;
a grouping of jets associated with each secondary manifold assembly, wherein each jet grouping includes a plurality of jets, each jet being connected to the respective discharge port of the secondary manifold assembly;
a pulsation module having a plurality of programmed operating modes that control the operation of the valves in the secondary manifold assembly for sequenced distribution of water from the jets;
wherein during operation of the pulsation system, the pump, the primary and secondary manifolds, and the pulsation module collectively interact to supply water to the various jet groupings whereby the jets discharge the water into the shell according to the operating mode of the pulsation module selected by a user.

2. The portable spa of claim 1, further comprising a primary controller operably connected to the pulsation module and the pump, wherein the primary controller monitors interaction of the pulsation system with additional operating components of the portable spa.

3. The portable spa of claim 2, wherein said additional operating components include an ozonator, a heater assembly and an electrical connection interface.

4. The portable spa of claim 2, further comprising a primary controller interface operably connected to the primary controller, wherein the controller interface is integrated in the shell.

5. The portable spa of claim 1, wherein the pulsation system further includes a pulsation module interface operably connected to the pulsation module, wherein the module interface is integrated in the shell proximate the seat associated with the pulsation system.

6. The portable spa of claim 1, wherein the pulsation system includes a suction assembly that supplies water to the pump.

7. The portable spa of claim 1, wherein each jet grouping defines a region of the associated seat, and wherein during operation of the pulsation system, water is discharged from the various regions according to the operating mode selected in the module.

8. The portable spa of claim 1, wherein the pulsation module is operably connected to each valve by electrical leads, and wherein the pulsation module sends a signal to open or close the valve along the electrical leads.

9. The portable spa of claim 1, further comprising a second pulsation system associated with a second seat of the shell.

10. The portable spa of claim 9, wherein the second pulsation system comprises the same components as the first pulsation system, and wherein during operation of the second pulsation system, the pump, the primary and secondary manifolds, and the module collectively interact to supply water to the various jet groupings whereby the jets discharge the water into the shell according to the operating mode.

11. The portable spa of claim 10, further comprising a primary controller that monitors operation of the first and second pulsation systems and the interaction of said pulsation systems with additional operating components.

12. The portable spa of claim 1, further comprising a massage ball assembly detachably connected to the shell.

13. The portable spa of claim 12, wherein the shell has a receiver that removably receives the massage ball assembly.

14. A portable spa comprising:
a shell having a plurality of seats;
a first pulsation system associated with a first seat and a second pulsation system associated with a second seat, wherein each pulsation system provides for the sequenced distribution of water and comprises:
a pump;
a manifold connected to the pump;
a plurality of jet groupings positioned throughout the shell, each jet grouping connected to the manifold and having a valve for controlling water flow from the pump to the jet grouping;
a module having preprogrammed operating modes that control operation of the valves associated with each jet group; and
an interface connected to the module for initiating one of the preprogrammed operating modes.

15. The spa of claim 14, wherein each jet grouping comprises a plurality of jets and an associated valve that is controlled by the controller module.

16. The spa of claim 14, further comprising an ozonator, a heater and a primary controller, wherein the primary controller monitors the interaction of the ozonator, the heater and the first and second pulsation systems.

17. The spa of claim 14, wherein the first and second pulsation systems each include a secondary manifold assembly connected to one of the plurality of jet groupings.

18. The spa of claim 17, wherein the secondary manifold includes a valve for controlling the flow of water through its associated jet grouping.

19. The spa of claim 18, wherein the secondary manifold valves are electrically connected to the module.

20. The spa of claim 14, wherein each jet grouping defines a region of the associated seat, and wherein during operation of the pulsation system, water is discharged from the various regions according to the operating mode selected in the module.

21. A portable spa comprising:
a shell having an arrangement of seats;
a primary controller; and,
a pulsation system associated with one of the seats and comprising:
a pump;
a primary manifold assembly that receives water from the pump, the primary manifold assembly having a first plurality of discharge ports;
a secondary manifold assembly connected to each discharge port of the primary manifold, the secondary manifold assembly having a valve and a second plurality of discharge ports;
a jet grouping associated with each secondary manifold assembly, wherein each jet grouping defines a region of the associated seat and includes a plurality of jets, each jet being connected to the respective discharge port of the secondary manifold assembly;
a module having a plurality of programmed operating modes that control the operation of the valves in the secondary manifold assembly for sequenced distribution of water from the jets;
wherein during operation of the pulsation system:
the primary controller, the pump, the primary and secondary manifolds, and the module collectively interact to discharge water from the various regions according to the selected operating mode of the module.

22. The portable spa of claim 21, wherein the primary controller monitors interaction of the pulsation system with an ozonator and a heater.

23. The portable spa of claim 21, wherein the pulsation system further includes a module interface operably connected to the module, wherein the module interface is integrated in the shell proximate the seat associated with the pulsation system.
